(19) United States
(12) Patent Application Publication
(10) Pub. No.: US 2015/0306437 A1
(43) Pub. Date: Oct. 29, 2015

(54) FIRE FIGHTING TOOL

(71) Applicants: Bryan HUNTER, Vancouver, WA (US); Andrew J. VILCAUSKAS, Vancouver, WA (US)

(72) Inventors: Bryan HUNTER, Vancouver, WA (US); Andrew J. VILCAUSKAS, Vancouver, WA (US)

(21) Appl. No.: 14/677,555

(22) Filed: Apr. 2, 2015

Related U.S. Application Data
(60) Provisional application No. 61/985,871, filed on Apr. 29, 2014.

(51) Int. Cl. A62C 31/02; B05B 3/10

(52) U.S. Cl. CPC A62C 31/02; B05B 3/1021

(57) ABSTRACT

A fire fighting tool.

### CROSS-REFERENCE TO RELATED APPLICATIONS

This application claims the benefit of U.S. Provisional Patent Application No. 61/985,871, filed Apr. 29, 2014.

### TECHNICAL FIELD

The present invention relates generally to fluid discharge nozzles, and in particular to a fire fighting tool for producing a swirling (rotating) fog pattern that has a forward thrust component.

### BACKGROUND OF THE INVENTION

The foregoing and other objectives, features, and advantages of the invention will be more readily understood upon consideration of the following detailed description of the invention, taken in conjunction with the accompanying drawings.

Spray discharge nozzles have many applications, and fire fighting is one of particular interest. It is well known that water absorbs not only heat but also many of the toxic gases of a fire and tends to clear away the smoke and does so most effectively when broken up into a fine spray or mist. Spray generating nozzles distribute the water discharge over a larger volume than do conventional fluid discharge nozzles in which water is discharged in a converging pattern of diffused solid streams. Spray generating nozzles are particularly useful in combating interior fires and are often used to provide protection for firefighting personnel by creating a water spray shield around the firefighters.

Conventional spray generating nozzles typically include a housing, a passageway for conducting water from a water supply source such as a fire hose from the inlet to the discharge end of the nozzle and a device for particulating the water to break it up into a fine stream. Multiple openings intersect the discharge end of the nozzle for directly diffusing the discharge spray outwardly from the nozzle. A commonly used device for particulating water is an internal impeller, which turns in response to the flow of water across obliquely inclined impeller surfaces inside the housing.

One limitation of conventional spray generating nozzles is that a high pressure source of water must be available to provide sufficient projection for the discharge spray. Because the discharge nozzle outlet is substantially smaller than the supply hose in order to produce a diffused spray, a back pressure builds up within the nozzle housing, thereby limiting the discharge flow rate. The use of an internal impeller to particulate the water also requires mechanical bearings and the like, which increases the cost and mechanical complexity of the nozzle.

U.S. Pat. No. 5,351,891 to Hansen and others show a fixed, non-rotatable spray head in which discharge orifices project a focused, converging jet spray discharge pattern.

The nozzle disclosed in U.S. Pat. No. 4,697,740 to Ivy is a substantial improvement over conventional spray nozzles by virtue of its ability to generate a large cloud of fog or fine mist that is particularly effective for smothering a blaze. This is made possible by a rotary nozzle in which the discharge orifices project water droplets radially outwardly thereby producing a static fog pattern. Because the cloud remains static or centered relative to the nozzle, it is necessary for fire fighting personnel to position the rotary nozzle in close proximity to the blaze in order for it to have effective coverage. Moreover, by placing the nozzle close to the fire source, the mist cloud becomes caught in the updraft and is pulled away from the fire. Because the static cloud is not controllable in direction, it is necessary for the nozzle to be attended by an observer so that it can be repositioned from time to time to maintain the protective thermal shield around the fire source.

A limitation of conventional fog-cloud or mist-cloud generator nozzles is that the movement of the fog cloud or mist pattern is not controllable in any particular direction, and tends to remain centered on the nozzle or to drift randomly. It is often necessary for fire fighter personnel to approach dangerously close to a very hot fire in order to establish a mist cloud and hold it centered on the fire, to establish a thermal shield that allows the fire fighting personnel to work safely, and to smother the fire until it is extinguished or brought under control. This exposes the fire fighters to risk of serious burn injury and smoke inhalation, particularly where chemical fuel source fires are involved.

For these reasons, there is a continuing interest in improving fire fighting equipment generally, and water spray projection equipment in particular, especially for use around intense blaze situations. Improvements are needed in water projection equipment that will extend the safe operational limits of standard protective clothing and respiration equipment, and allow fire fighting personnel to work safely and effectively in close proximity to a fire source.

### BRIEF DESCRIPTION OF THE SEVERAL VIEWS OF THE DRAWINGS

FIG. 1 is an elevational view of a fog generating nozzle constructed according to the present invention.

FIG. 2 is a sectional view of the nozzle of FIG. 1, taken along the line 2-2.

FIG. 3 is a perspective view of a rotor sleeve component of the fog generating nozzle shown in FIG. 1.

FIG. 4 is a sectional view of the rotor sleeve component, taken along the line 4-4 of FIG. 1.

FIG. 5 is a perspective view of a bearing member component of the fog generating nozzle shown in FIG. 1.

FIG. 6 is a sectional view of the bearing member component, taken along the line 6-6 of FIG. 5.

FIG. 7 is a side elevational view, partially broken away, of a fire fighting tool constructed according to the present invention, having a bumper cap and fog generating nozzle disposed thereon.

FIG. 8 is a perspective view of the bearing member component of the nozzle as removed from the fire fighting tool shown in FIG. 7.

FIG. 9 is a plan view of a dual, counter-rotating nozzle installation for generating a swirling (rotating) fog pattern or cloud that has a forward thrust component, swirling in counter-rotation relation to the other nozzle.

FIG. 10 is a perspective view of portable, freestanding tripod units, each equipped with counter-rotating nozzles set-up for generating mist clouds that merge, thereby producing a thermal mist curtain adjacent a chemical fire source.

FIG. 11 is a side elevation view of a self-contained, portable tank unit with an internal pump, onboard power unit and dual counter-rotating nozzles.

FIG. 12 is a front elevational view thereof.

FIG. 13 is a simplified schematic view showing the interconnection of intake conduit, pump, drive motor, manifold and dual mist generating nozzles on the portable tank unit of FIG. 11.

FIG. 14 is a side view of another embodiment of a rotor sleeve component.

FIG. 15 is a perspective breakaway view of another embodiment of a rotator sleeve component.

FIG. 16 is a side view of another embodiment of a rotor sleeve component.

FIG. 17 is a side view of another embodiment of a rotor sleeve component.

FIG. 18 is a side view of another embodiment of a rotor sleeve component.

### DETAILED DESCRIPTION OF PREFERRED EMBODIMENT

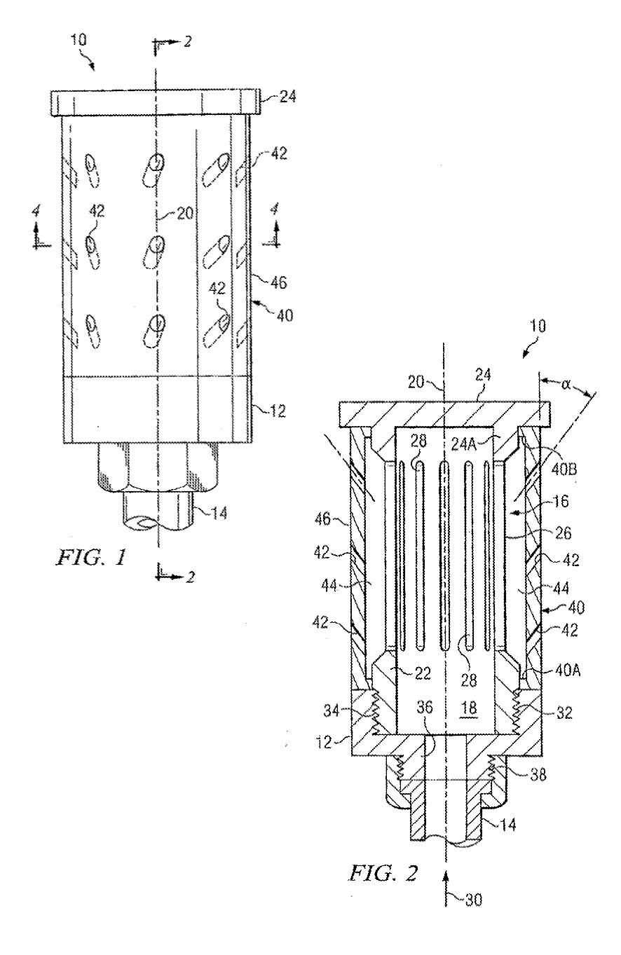

Referring to FIGS. 1 and 2, a fog generating nozzle 10 is threadedly connected to a coupling member 12, which in turn is threadedly connected to a fluid conduit 14, such as a water pipe or hose. Water conduit 14 is adapted for connection to a supply main (not shown) for pressurizing the nozzle 10.

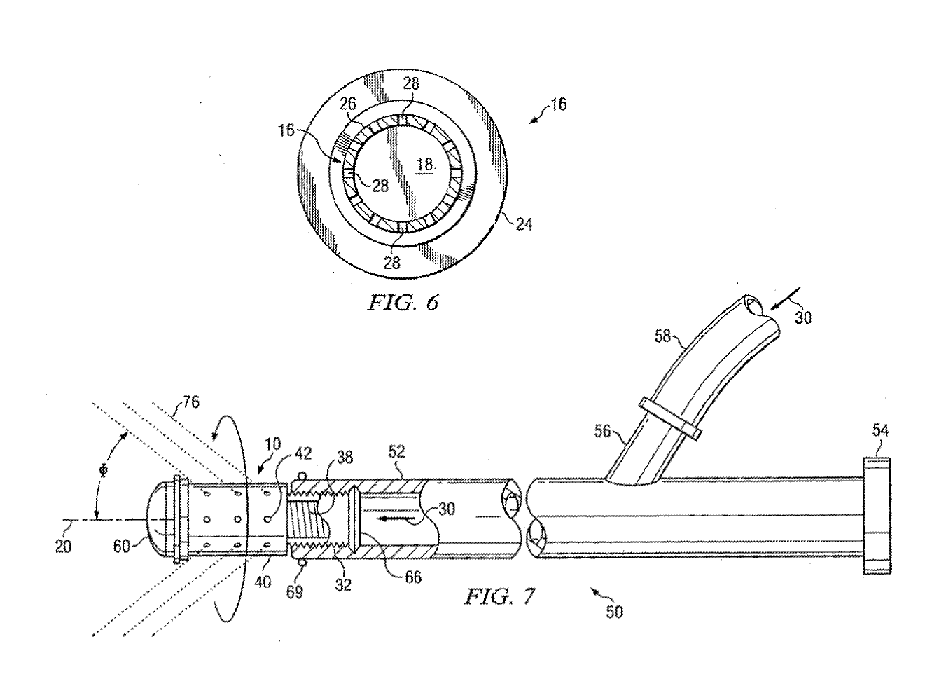

As can be seen in FIGS. 2, 5 and 6, the nozzle 10 includes a cylindrical bearing member 16, having a fluid passageway 18 extending along a longitudinal axis 20 from a threaded base member 22 to a closed top member 24. A reduced diameter sidewall portion 26 of bearing member 16 has a plurality of axially extending distribution openings in the form of elongated slots 28 disposed at angularly spaced intervals thereon. The combined discharge area of the slots 28 exceeds the cross sectional area of the supply conduit 14, thereby admitting pressurized water 30 into passage 18, without imposing substantial back pressure.

The base portion 22 is threaded at 32 and functions as a male member for mating with corresponding threads 34 on a female end of coupling 12, as shown in FIG. 2, to connect bearing member 16 to the supply conduit 14. The corresponding male end 36 of coupling 12 is threadedly connected at 38 to the corresponding female end of fluid conduit 14, as also shown in FIG. 2. The threaded base member 22 is open to admit water flow and is provided with a cylindrical shoulder extension 22A which connects the threaded base portion to the reduced diameter sidewall portion. Likewise, closed top member 24 is provided with a cylindrical shoulder extension 24A, connecting it to the reduced diameter sidewall portion.

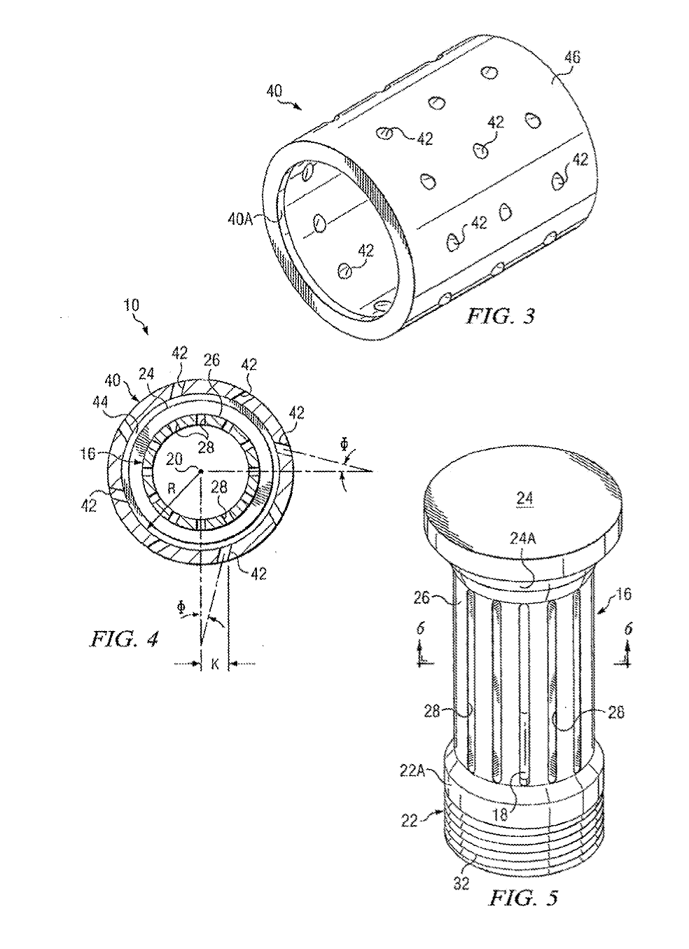

Referring to FIGS. 2, 3 and 4, a rotor sleeve 40 is coupled for rotation on the bearing member 16 to form the nozzle 10. The rotor sleeve 40 is a hollow, cylindrical member intersected by a plurality of orifices 42 which preferably are equally spaced along respective parallel lines of circumference around the rotor sleeve 40. The discharge orifices 42 intersect through the rotor sidewall 46 transversely at an acute pitch angle .alpha. with respect to the rotary axis 20, thus giving the mist particles a forward component of directional movement as they are discharged.

The pitch angle .alpha. is preferably in the range of from about 30-45 degrees, and more preferably in the range of about 35-42 degrees, as shown in FIG. 2. Other angles, or multiple angles, may likewise be used. This arrangement produces a forward directional cloud movement component in line with the rotary axis. The rotational direction imparted by the water is preferably counter to the threading so that the head does not unscrew or loosen from the base of the nozzle.

The orifices 42 also extend transversely at an acute angle .PHI. with respect to corresponding lines of radius R of rotor sleeve 40 so that a turning force is imparted to sleeve 40 when water is discharged through orifices 42. The angle .PHI. is preferably equal to about 30 degrees as measured from the orifice axis A to the principal radius line R, as shown in FIG. 4. This measurement is taken with the orifice 42 offset from the radius R by an offset spacing K (K=¼ inch for R=1 inch).

The rotor sleeve 40 is positioned concentric with bearing member 16 and is rotatable with respect to bearing member 16. As shown in FIG. 2, rotor sleeve 40 surrounds central portion 26 and slots 28 in their entirety and partially overlaps base member 22 and top member 24. Rotor sleeve 40 includes radial flange portions 40A, 40B which maintain sleeve 40 in generally concentric alignment with bearing member 16. Flange portions 40A, 40B are dimensioned to permit a slight amount of radial as well as axial end play.

An annular chamber 44 is defined between bearing member 16 and rotor sleeve 40. When water 30 flows into passageway 18 under pressure, annular chamber 44 is pressurized with water to provide a water cushion upon which rotor sleeve 40 rides during rotation. Water flowing into passageway 18 will flow through slots 28 into annular chamber 44 and outwardly through orifices 42, thereby causing rotor sleeve 40 to rotate around bearing member 16.

The discharge of water 30 through the orifices 42 creates a reaction force having a component which is tangential to the curved surface 46 of the rotor sleeve 40, as well as a component which is normal thereto. The tangential component imparts rotational motion to sleeve 40 in much the same manner that a jet engine turbine is turned by the reaction force produced by the flow of combustion gases through the engine nozzles. The centrifugal force associated with the rotation of rotor sleeve 40 breaks up the water particles into a fine mist or fog. The water particles travel outwardly in a substantially spiral pattern. Thus, the water particles are carried a sufficient distance to enable the nozzle 10 to be effectively used for firefighting purposes and/or other fixed fire suppression systems.

The nozzle 10 discharges a greater volume of water than conventional nozzles (1260 gallons per minute as compared to 65 gallons per minute for conventional convergent nozzles) and distributes the fog or mist discharge over a larger area. The improved G.P.M. delivery is obtained because of the low back pressure presented by operation of the cylindrical bearing and rotatable sleeve, and due to the absence of frictional loading associated with conventional mechanical roller bearing structures.

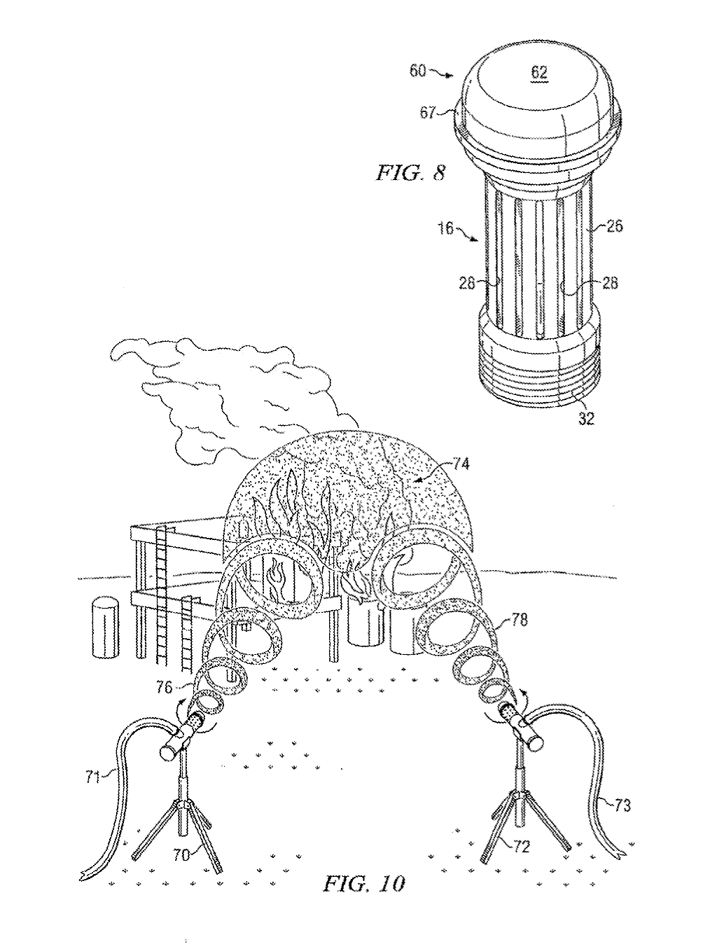

In another embodiment, a hand-held firefighting tool 50 is depicted in FIGS. 7 and 8. The tool 50 includes a tubular shaft 52 having an end cap 54 sealing one end thereof and a fitting 56 extending outwardly from shaft 52 for coupling engagement with a fire hose 58 or the like. Mounted on the opposite end of shaft 52 are the nozzle 10 and a bumper cap 60, having a rounded face 62 to provide a relatively smooth surface on the forward end for opposing penetration when working around building structure such as machinery, flow conduits, tubing, tanks and the like. The bumper cap 60 is preferably machined from stainless steel stock. The means for connecting the tool 50 to the fluid supply hose 58 is a Y-branch connector fitting 56 integrally formed on the shaft member and having a longitudinal axis that extends transversely with respect to the longitudinal axis of the shaft member. The fluid discharge device, shaft member and connector fitting are also preferably formed of stainless steel stock material.

The forward end of shaft 52 is equipped with female threads 66 for engaging corresponding threads 32 on bearing member 16, to couple the nozzle 10 to the shaft 52. In one embodiment, the bumper cap 60 is integrally formed on the forward end of the bearing member 16. In an alternate embodiment, the bearing member 16 is equipped with male threads on or adjacent to the top portion 24 for engaging corresponding female threads on the bumper cap 60. In both embodiments, the nozzle 10 is disposed immediately behind the bumper cap 60 and flush with tubular shaft 52. According to this arrangement, the nozzle 10 is protected from damage resulting from inadvertent engagement of the nozzle against building structure and equipment.

Referring again to FIGS. 7 and 8, safety rings 67, 69 are formed on the external surface of the bumper cap 60 and the tubular shaft 52, respectively. The safety rings 67, 69 are annular weld beads located immediately forward and aft of the rotor sleeve 40. The safety ring 67 minimizes scraping engagement of the building structure against the rotor sleeve 40. The safety ring 69 serves the same purpose. According to this arrangement, the rotor sleeve 40 is protected against damaging impact force which might bend it and cause it to become unbalanced.

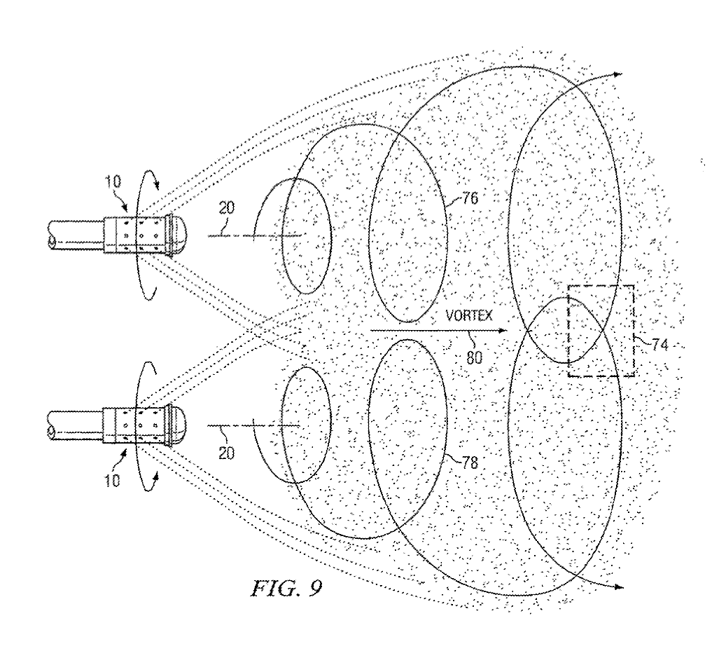

Referring now to FIG. 9 and FIG. 10, free-standing tripod units 70, 72 are equipped with counter-rotating nozzles 10 and high pressure water conduits 71, 73 for set-up at safe, remote locations away from a fire source of intense heat, for example a burning portion of a petrochemical processing plant 74 is shown in FIG. 10. Swirling mist particles are discharged from the counter-rotating nozzles and are represented by the spiral lines 76, 78. These swirling mist clouds have a forward thrust component that projects the mist forward along the nozzle axis 20. The swirling mist particles move forward and merge along a common vortex 80 to project a protective fog curtain or cloud onto or about the fire source 74 for fire suppression and thermal shielding purposes. This allows fire fighting personnel to quickly set up the tripod units to gain initial control with protection of a thermal shield, and then repositing the tripod units.

The centrifugal force associated with the rotation of the sleeve member 40 particulates the water into finely divided mist particles and discharges the mist forwardly in a swirling, spiral pattern 76, 78. Extended coverage is obtained from available high pressure supply mains, and because of the substantially reduced back pressure, a large delivery rate approaching the supply conduit flow rate is obtained, thus enabling it to extinguish a fire and cool down the source prior to approach by firefighting personnel.

Because of the finely particulated nature of the discharged water droplets, heat from the fire source 74 will cause approximately 80% of the water droplets to flash to steam, thereby removing heat from the fire by increasing the temperature of the discharged water droplets to the flash point and by latent heat of vaporization which causes the water droplets to make the transition to the vapor state. For example, one cubic foot of water will produce approximately 1700 cubic feet of steam. The resulting steam forms a blanket around the fire source 74, which reduces the amount of oxygen available so as to “choke off” the fire. Moreover, the fog and steam propagate throughout the structure surrounding the fire source and into spaces that otherwise could not be reached. Even if the fire cannot be completely extinguished, the fire source will be cooled down sufficiently to allow firemen to work and move about in close proximity with additional hoses and fire fighting equipment to extinguish the fire. Other sizes of particulated discharged water may likewise be used.

One skilled in the art will recognize that the fog generating nozzle 10 of the present invention has many applications in addition to portable fire fighting equipment. For example, the nozzle 10 may be coupled to a rigid water pipe or flexible water hose and installed in a central location within a greenhouse or other enclosure in which humidity control is desired. The nozzle 10 can be pressurized periodically, as desired, to discharge a large volume of fog or mist which will propagate throughout the enclosure to maintain a desired humidity level. Moreover, a system of nozzles 10 can be installed in a building structure as an integral part of an automatic fire extinguishing system.

Preferred specifications for the nozzle 10: nozzle net weight—24 lbs. rotor material—carbon-filled Teflon angle of discharge apertures in rotor—35 .degree.-42 .degree., bore size 3/16 in. diameter barrel of nozzle material—Schedule 40 stainless steel seamless pipe nozzle water connection—1.5 in. National (Fire Thpe) or 1.5 in. shutoff valve nozzle flow rating GPM at 175 psi-1260 G.P.M. Other materials and/or weights may likewise be used, as desired.

The nozzle 10 constructed with the preferred dimensions given above offers more protection for firefighters and also provides a higher GPM flow. Specifically, the protection this improved design offers is a more dense fog pattern. This dense fog pattern provides a very high reduction in temperatures that firefighters are subjected to while approaching a burning structure or chemical fire.

In an industrial setting, i.e. chemical, petroleum and the like, there are piping, electrical, water, etc. systems running throughout the plant. A sharp, pointed tip is not always needed in a more open industrial plant environment which is often congested with vital supply lines that maintain the operation of the plant. In an industrial setting, most of the fires are related to the product that the plant produces, i.e. LPG, gasoline, diesel, jet fuel, etc. The improved nozzle 10 offers firefighters an option to any given fire situation. The blunt bumper cap poses no risk of penetration damage to surrounding infrastructure.

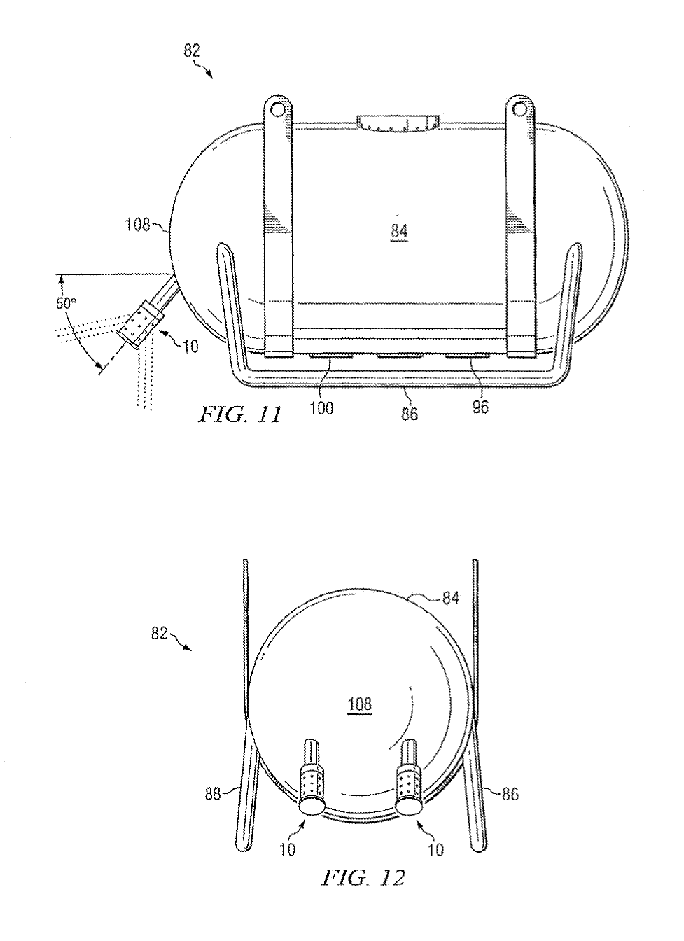

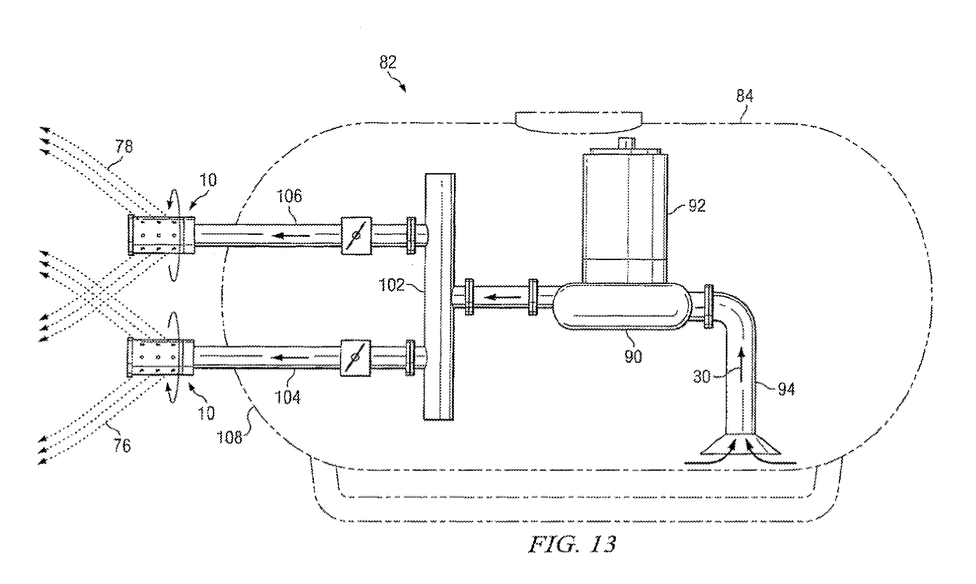

Referring now to FIGS. 11, 12 and 13, a portable tank unit 82 makes use of the improved nozzle 10 for fighting wildfires. The portable tank unit 82 is skid mounted and capable of stand-alone operation, supplying high pressure water to tripod-mounted or hand-held nozzle operation, or can be slung below a helicopter for remote aerial stand-off operation, or truck-mounted for transport and set-up to supply a hand-held fire fighting nozzle or a tripod-mounted nozzle for operations where road access is available.

The tank unit 82 includes a 1500-gallon stainless steel tank 84 with dished ends, two skids 86, 88, a self-contained submersible pump 90, an electric drive motor 92, intake conduit 94, one-way fill valves 96, 98, 100 located on the bottom side of the tank, a distribution manifold 102, and internal interconnect piping. Discharge conduits 104, 106 extend from the manifold through one dished end 108 the tank at a 50 .degree. angle downward. There are two 3-inch diameter stainless steel conduits that form the working end of the tank system. Two mist generators 10 are mounted on the end of the discharge conduits. The rotor orifices of these nozzles are drilled at an angle that provides a forward thrust of the fog pattern, and counter-rotation rotor movement relative to each other.

With both mist generator patterns 76, 78 intersecting or converging on one another, rotating in opposite directions creates a thrust vortex 80 between the two nozzles, as shown in FIG. 9. This vortex adds a push to the fog cloud.

In a wildfire operation, the portable tank unit 82 is brought to the site of the wildfire via helicopter. The tank unit 82 is slung via a tether line below the helicopter loitering at a stand off position adjacent a burning forest canopy, and the fog cloud is projected from the dual nozzles onto the burning canopy. As the fog cloud contacts the burning canopy it is turned into steam almost instantly, thus cooling the ambient temperature and removing a significant amount of heat from the area. It also blankets the area with a thick fog that removes a significant amount of oxygen from the burning canopy. The tank system 82 may provide a fog pattern approximately 120 feet wide, and when loaded with 1500 gallons of water covers a path of approximately one-quarter mile in length.

The electrical power supply for the tank unit's self-contained drive motor 92 is located in the helicopter and is operated by one of the crew. The tank unit can also be mounted on a truck or off-road vehicle that can be deployed ahead of the fire. The tank system creates a dense fog cover at lower elevations beneath the canopy. This dense fog cools the ambient temperature and at the same time soaks the forest floor vegetation, thus reducing the fuel element of the fire triangle.

While the fire fighting tool of FIG. 7 is generally effective, it turns out that when the fire fighting tool is plunged into particular locations that include a lot of materials and/or debris, the forwardly projecting water does not sufficiently suppress the fire. In particular, especially within spatially restricted environments, the forwardly projecting water fails to adequately suppress fire positioned at a more lateral position to the fire fighting tool. Moreover, pulling the fire fighting tool backwards likewise may not adequately suppress the fire because similarly an insufficient amount of water will reach the fire within the spatially restricted environment.

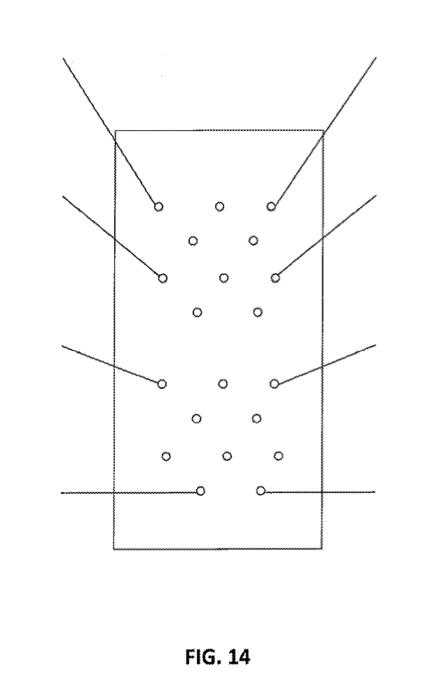

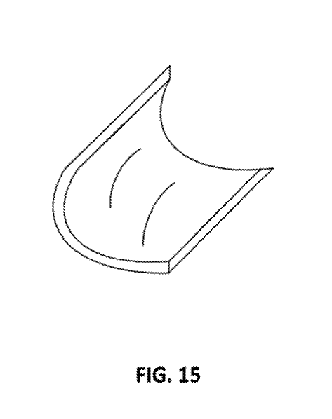

Referring to FIG. 14, a fog generating nozzle may include a modified rotator sleeve that is a hollow, cylindrical member intersected by a plurality of orifices which are preferably equally spaced along respective parallel lines of circumference around the rotor sleeve. The discharge orifices intersect through the rotor sidewall traversely at different angular pitches with respect to the rotary axis, thus giving the mist particles a variable forward component of directional movement as they are discharged. Also, one or more of the discharge orifices may intersect the rotor sidewall at a substantially perpendicular pitch with respect to the rotary axis, thus giving part of the mist particles a substantially horizontal component of directional movement as they are discharged. In this manner, there is a higher likelihood of having a sufficient amount of water to reach the fire within spatially restricted environments.

The holes may be arranged in a spatially varying arrangement on the rotator sleeve, as desired. The angular orientation of the holes may be in an angular varying arrangement on the rotator sleeve, as desired. The size of the holes may be in a varying arrangement on the rotator sleeve, as desired. The shape of the holes may be in other configurations, such as slits, ovals, as desired.

If the water pressure is relatively low, it may be difficult to generate sufficient rotational movement of the rotator sleeve to generate the desirable amount of fog for fire suppression. Referring to FIG. 15, depending on the water pressure, it may be desirable to include one or more internal ribs at an angular relationship to the rotary axis within the rotator sleeve. The water exerts pressure against the internal ribs in a manner which increases the rotational movement of the rotator sleeve so that there is a higher likelihood of sufficient rotational movement to generate the desirable amount of fog for fire suppression. In addition, a set of cuts into the interior walls of the rotator sleeve at an angular relationship to the rotary axis may be used to increase the rotational movement of the rotator sleeve.

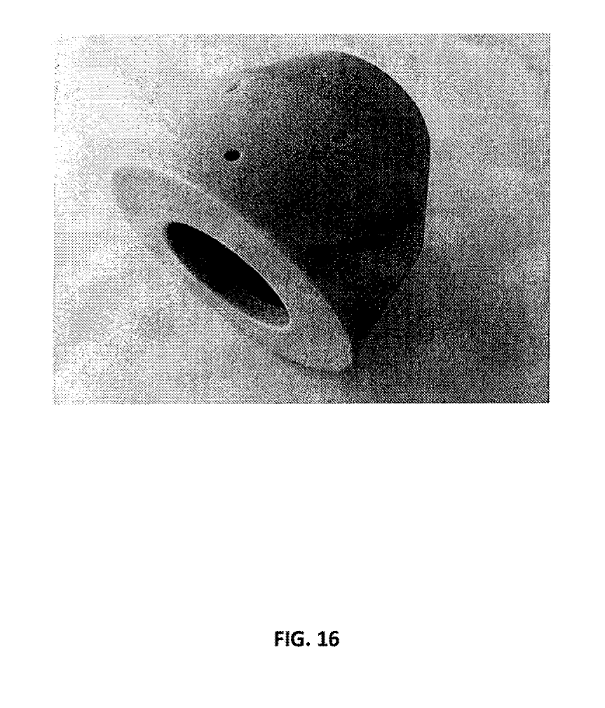

In some environments it is desirable to have a significant portion of the water being directed in a substantially forward direction, but the closed top member tends to impede such substantially forwardly directed water. Referring to FIG. 16, a modified rotator sleeve includes a forward cone shaped portion that increases the diameter of the rotator sleeve. The cone shaped portion may likewise be of any shape and configuration to increase the horizontal spacing of the openings relative to the closed top member. The forward cone shaped portion may include openings therein that direct water substantially in line with the rotator axis, which in this manner are generally directed around the closed top member. The remaining portion of the rotator sleeve may include a substantially cylindrical portion with openings defined therein, as previously described. For example, the openings in the cone portion may be directed substantially in line with the rotator axis, the openings in the forward portion of the cylindrical portion may be directed at forward acute angle with respect to the rotator axis, and the openings in the rearward portion of the cylindrical portion may be directed at a substantially perpendicular direction with respect to the rotator axis.

Depending on the particular location of the fire, it may be desirable to provide a more compressed directional stream of the water or it may be desirable to provide a more dispersed stream of the water. While changing the directionality of the stream by changing the entire fog generating module is possible, it was determined that a modified technique for generating different fog patterns is desirable, especially during the process of suppressing a fire. The preferred technique to generate different fog patterns is by changing the rotational speed of the rotator sleeve by including a regulator to selectively change the pressure of the water being provided to the rotator sleeve. In addition, the regulator may include added external air pressure from an air hose to increase the available pressure. As an example, at 50 psi the water generally follows the directional orientation of the openings. As an example, at 100 psi the water generally is more forwardly directed than at 50 psi. For example, at 100 psi the water may be generally 9 feet wide at 20 feet; at 125 psi the water may be generally 7 feet wide at 20 feet; and at 150 psi the water may be generally 5 feet wide at 20 feet.

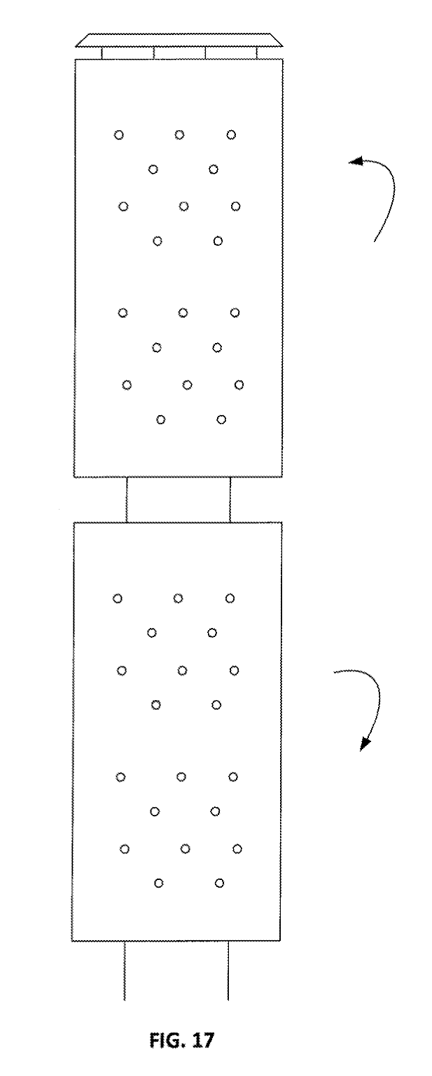

Referring to FIG. 17, in some situations it is desirable to include a plurality of rotator sleeves in an in-line orientation. The openings of the one of the rotator sleeves may be arranged to spin the rotator in a first direction (e.g., clockwise). The openings of the other of the rotator sleeves may be arranged to spin the rotator in a second opposite direction (e.g., counter-clockwise). Spinning the rotator sleeves in different directions tends to generate different patterns which tend to be effective at fire suppression. Also, the rotators may rotate in the same direction, if desired. In addition, each of the rotator sleeves may have a different hole pattern. The forward rotator sleeve may have generally forwardly directed openings to provide fire suppression in a forward direction, while the rearward rotator sleeve may have a generally perpendicular directed openings to provide fire suppression in a perpendicular direction. Also, a regulator may be used to change the rotational speeds of the sleeves relative to each other.

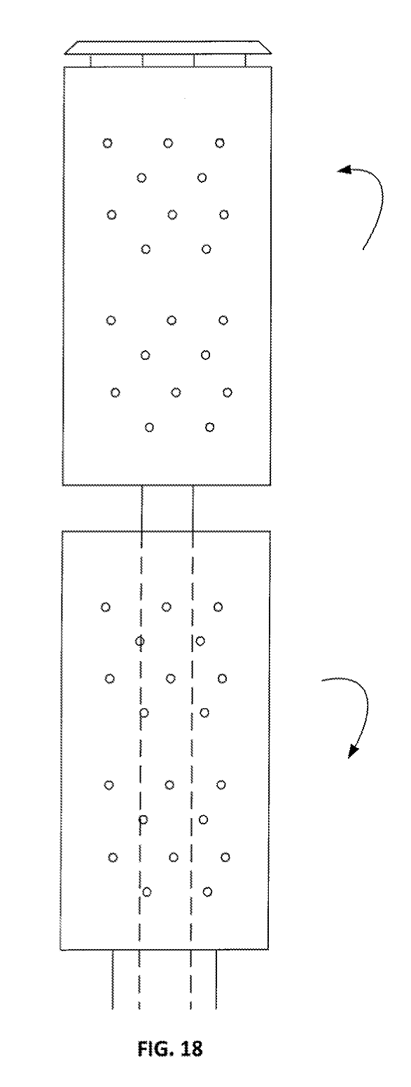

Referring to FIG. 18, in some situations it is desirable to include a plurality of rotator sleeves in an in-line orientation together with multiple chemical paths. The openings of the one of the rotator sleeves may be arranged to spin the rotator in a first direction (e.g., clockwise). The openings of the other of the rotator sleeves may be arranged to spin the rotator in a second opposite direction (e.g., counter-clockwise). Spinning the rotator sleeves in different directions tends to generate different patterns which tend to be effective at fire suppression. Also, the rotators may rotate in the same direction, if desired. In addition, each of the rotator sleeves may have a different hole pattern. The forward rotator sleeve may have generally forwardly directed openings to provide fire suppression in a forward direction, while the rearward rotator sleeve may have a generally perpendicular directed openings to provide fire suppression in a perpendicular direction. The fluid passageway may include a plurality of separate passageways so that different fluids may be provided to different rotator sleeves. For example, a pair of coaxial tubes may be supplied to the rotators. The outer coaxial tube may provide fluid to the rearward rotator to spin the rotator with the exterior fluid. The inner coaxial tube may provide fluid through the rearward rotator to the forward rotator to spin the forward rotator with the inner fluid. For example, the forward rotator may dispense a dry chemical while the rearward rotator may dispense a wet chemical.

In another embodiment, the entire nozzle assembly may rotate, if desired. In addition, the entire nozzle assembly may rotate at a first rate while the rotator sleeves rotate at a different speed. Also, the rotator sleeves may be maintained in a non-rotational position while the inner nozzle assembly rotates.

Although the invention has been described with reference to certain exemplary arrangements, it is to be understood that the forms of the invention shown and described are to be treated as preferred embodiments. Various changes, substitutions and modifications can be realized without departing from the spirit and scope of the invention as defined by the appended claims.

I claim:

1. A sprinkler comprising:
(a) said sprinkler defining an inlet port and a plurality of discharge ports and an internal passageway extending between said inlet port and said discharge ports;
(b) said sprinkler including a bearing member defining a portion of said internal passageway between said inlet port and said discharge ports;
(c) said sprinkler including a rotator sleeve rotatably interconnected to said bearing member defining said discharge ports;
(d) said rotator sleeve having a central axis of rotation and defining said discharge ports in such a manner that the angular relationship of a plurality of said discharge ports with respect to said central axis of rotation are different from one another.

2. The sprinkler of claim 1 further comprising a base member defining threaded portion of said inlet port.

3. The sprinkler of claim 2 further comprising said bearing member defining a plurality of openings therein defining said portion of said internal passageway between said inlet port and said discharge ports.

4. The sprinkler of claim 3 wherein said bearing member wherein said plurality of openings are elongated slots displaced at angularly spaced intervals of said bearing member.

5. The sprinkler of claim 2 wherein said inlet port is threadedly connectable to a fluid conduit.

6. The sprinkler of claim 2 wherein bearing member is threadedly connectable to said base member.

7. The sprinkler of claim 6 wherein said bearing member defines an end portion thereof.

8. The sprinkler of claim 1 wherein said angular relationship of said discharge ports with respect to said central axis of include a plurality of said discharge ports that are at a substantially perpendicular pitch with respect to said central axis and a plurality of said discharge ports that are at an acute forward angle with respect to said central axis.

9. The sprinkler of claim 1 wherein said angular relationship of said discharge ports with respect to said central axis of include a plurality of said discharge ports that are at a substantially perpendicular pitch with respect to said central axis, a plurality of said discharge ports that are at an acute forward angle with respect to said central axis, and a plurality of said discharge portions are at an acute rearward angle with respect to said central axis.

10. The sprinkler of claim 1 wherein said angular relationship of said discharge ports with respect to said central axis of include a plurality of said discharge ports that are at an acute forward angle with respect to said central axis and arranged in a spatially varying arrangement with respect to one another.

11. The sprinkler of claim 1 wherein said angular relationship of said discharge ports with respect to said central axis of include a plurality of said discharge ports that are at an acute forward angle with respect to said central axis and the size of said discharge ports are in a varying arrangement with respect to one another.

12. The sprinkler of claim 1 wherein said angular relationship of said discharge ports with respect to said central axis of include a plurality of said discharge ports that are at an acute forward angle with respect to said central axis and the shape of said discharge ports are in a varying arrangement with respect to one another.

13. The sprinkler of claim 12 wherein said shape is an oval.

14. The sprinkler of claim 12 wherein said shape is a slit.

15. The sprinkler of claim 1 wherein an interior surface of said rotator sleeve defines at least one internal rib.

16. The sprinkler of claim 15 wherein said at least one internal rib is not aligned in a parallel manner with respect to said central axis.

17. The sprinkler of claim 1 wherein an interior surface of said rotator sleeve defines at least one internal cut.

18. The sprinkler of claim 17 wherein said at least one internal cut is not aligned in a parallel manner with respect to said central axis.

19. The sprinkler of claim 1 wherein said rotator sleeve includes a cylindrical shaped portion and a cone shaped portion.

20. The sprinkler of claim 1 wherein said rotator sleeve includes an exterior surface that has a greater distance from said central axis than any portion of an exterior surface of said bearing member.

21. The sprinkler of claim 19 wherein at least one of said discharge ports is defined by said cone shaped portion.

22. The sprinkler of claim 21 wherein said at least one of said discharge ports defined by said cone shaped portion are substantially aligned with said central axis.

23. The sprinkler of claim 21 further comprising a regulator to selectively change the pressure of a fluid passing between said inlet port and said outlet ports.

24. The sprinkler of claim 23 wherein further comprising a connector to an external air pressure source to increase the pressure of said fluid passing between said inlet port and said outlet ports.

25. The sprinkler of claim 1 further comprising another rotator sleeve rotatably interconnected to said bearing member defining said discharge ports.

26. The sprinkler of claim 25 wherein said discharge ports in said rotator sleeve result in said rotator sleeve rotating in a first direction and said discharge ports in said another rotator sleeve result in said another rotator sleeve rotation in a second direction different than said first direction.

27. The sprinkler of claim 25 wherein said discharge ports in said rotator sleeve result in said rotator sleeve rotating in a first direction and said discharge ports in said another rotator sleeve result in said another rotator sleeve rotation in said first direction.

28. The sprinkler of claim 25 further comprising a regulator to selective change a rotational speed of said rotator sleeve relative to a rotational speed of said another rotator sleeve.

29. The sprinkler of claim 25 wherein said rotator sleeve and said another rotator sleeve include separate fluid passageways from said inlet port.

30. The sprinkler of claim 29 wherein said separate fluid passageways are coaxial.
